(19) United States
(12) Patent Application Publication
(10) Pub. No.: US 2005/0220293 A1
(43) Pub. Date: Oct. 6, 2005

(54) Subscriber loop interface circuitry with tracking battery supply

(76) Inventors: Jerrell P. Hein, Driftwood, TX (US); Marius Goldenberg, Austin, TX (US)

Correspondence Address: DAVIS & ASSOCIATES, P.O. BOX 1093, DRIPPING SPRINGS, TX, 78620, US

(21) Appl. No.: 11/088,248

(22) Filed: Mar. 23, 2005

Related U.S. Application Data
(63) Continuation of application No. 09/696,900, filed on Oct. 25, 2000.

(51) Int. Cl. H04M 1/00

(52) U.S. Cl. 379/413

(57) ABSTRACT

A subscriber line interface apparatus includes a switching core generating a negative subscriber line battery supply voltage (V_{BAT}) for supplying at least one of a tip line and a ring line of a subscriber line from a positive first supply voltage. The apparatus includes voltage control circuitry driving the switching core in accordance with a tracked signal corresponding to a sensed one of the tip and ring lines.

### CROSS-REFERENCE TO RELATED APPLICATIONS

The present application is a continuation of application Ser. No. 09/696,900 of Hein, et al. filed on Oct. 25, 2000.

### FIELD OF THE INVENTION

This invention relates to the field of telecommunications. In particular, this invention is drawn to subscriber loop interface circuitry.

### BACKGROUND OF THE INVENTION

Subscriber line interface circuits are typically found in the central office exchange of a telecommunications network. A subscriber line interface circuit (SLIC) provides a communications interface between the digital switching network of a central office and an analog subscriber line. The analog subscriber line connects to a subscriber station or telephone instrument at a location remote from the central office exchange.

The analog subscriber line and subscriber equipment form a subscriber loop. The interface requirements of an SLIC result in the need to provide relatively high voltages and currents for control signaling with respect to the subscriber equipment on the subscriber loop. Voiceband communications are low voltage analog signals on the subscriber loop. Thus the SLIC must detect and transform low voltage analog signals into digital data for transmitting communications received from the subscriber equipment to the digital network. For bi-directional communication, the SLIC must also transform digital data received from the digital network into low voltage analog signals for transmission on the subscriber loop to the subscriber equipment. Strict gain and longitudinal balance control are required for subscriber loop applications.

The control signaling requirements vary depending upon the state of the subscriber equipment. When the subscriber equipment is “on hook”, the SLIC should maintain the subscriber loop voltage at a relatively large negative value of approximately −48 Volts. When the subscriber equipment is “off hook,” the SLIC is predominately a constant current source for the subscriber loop. Depending upon the length and impedance of the subscriber loop the “off hook” loop voltage could range from −8 Volts to −48 Volts.

The SLIC must be provided with a negative voltage supply sufficient to accommodate the most negative loop voltage while maintaining the SLIC internal circuitry in their normal region of operation. The use of a single fixed negative power supply tends to result in unnecessary power dissipation.

One solution is to provide multiple negative power supplies, each associated with a particular state of the subscriber equipment. The SLIC automatically selects between the multiple power supplies depending upon the state of the subscriber equipment. Although unnecessary power dissipation may be alleviated, the use of multiple power supplies is disadvantageous and provides only a coarse reduction of the power dissipation. Short length subscriber loops may still undesirably dissipate power.

### SUMMARY

A subscriber line interface apparatus includes a switching core generating a negative subscriber line battery supply voltage (V_{BAT}) for supplying at least one of a tip line and a ring line of a subscriber line from a positive first supply voltage. The apparatus includes voltage control circuitry driving the switching core in accordance with a tracked signal corresponding to a sensed one of the tip and ring lines.

One embodiment of a subscriber line interface circuit apparatus includes voltage control circuitry varying V_{BAT} to track at least one of a tip and a ring signal as a tracked signal. A switching core generates V_{BAT} from a first supply voltage that is more positive than V_{BAT}.

Another embodiment of a subscriber line interface circuit apparatus includes a switching core generating a negative V_{BAT} from a positive first supply voltage. Voltage control circuitry controls the switching core in accordance with a programmable reference voltage.

### BRIEF DESCRIPTION OF THE DRAWINGS

The present invention is illustrated by way of example and not limitation in the figures of the accompanying drawings, in which like references indicate similar elements and in which:

FIG. 1 illustrates one embodiment of a central office exchange including a subscriber line interface circuit (SLIC) coupling subscriber equipment to a digital switching system.

FIG. 2 illustrates a block diagram of an SLIC including a signal processor and a linefeed driver.

FIG. 3 illustrates high voltage precision matched operational amplifiers for driving tip and ring line voltages.

FIG. 4 illustrates one embodiment of a linefeed driver circuit.

FIG. 5 illustrates current differencing and mirroring circuitry.

FIG. 6 illustrates the current differencing and mirroring circuitry used to generate feedback error signals for the tip and ring control circuitry within the signal processor.

FIG. 7 illustrates control and generation of the battery supply voltage, V_{BAT} .

### DETAILED DESCRIPTION

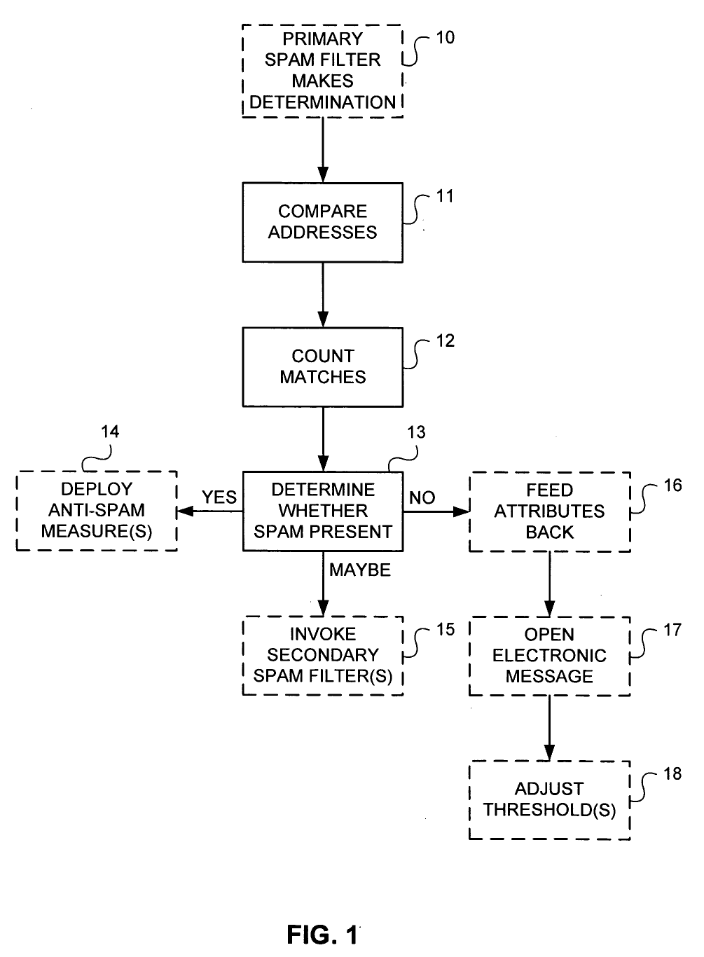

FIG. 1 illustrates functional elements of one embodiment of a subscriber line interface circuit (SLIC) 110 typically associated with plain old telephone services (POTS) telephone lines. The subscriber line interface circuit (SLIC) provides an interface between a digital switching network 120 of a local telephone company central exchange and a subscriber loop 132 including subscriber equipment 130.

The subscriber loop 132 is typically used for communicating analog data signals (e.g., voiceband communications) as well as subscriber loop “handshaking” or control signals. The analog data signals are typically on the order of 1 volt peak-to-peak (i.e., “small signal”). The subscriber loop control signals typically consist of a 48 VDC offset and an AC signal of 40-140 Vrms (i.e., “large signal”). The subscriber loop state is often specified in terms of the tip 180 and ring 190 portions of the subscriber loop.

The SLIC is expected to perform a number of functions often collectively referred to as the BORSCHT requirements. BORSCHT is an acronym for “battery feed,” “overvoltage protection,” “ring,” “supervision,” “codec,” “hybrid,” and “test.”

Recent transformerless SLIC designs tend to distribute the functional requirements between two integrated circuits based on whether the functions are traditionally associated with the high voltage subscriber loop controls or the low voltage data processing. For example, in one embodiment, the codec is implemented in a low voltage integrated circuit and the remaining functions (e.g., supervision) are implemented primarily in a high voltage integrated circuit such as a bipolar integrated circuit. Although this design tends to offer considerable space, weight, and power efficiencies over designs requiring passive inductive components, this distribution of the functional requirements tends to result in a relatively expensive high voltage integrated circuit.

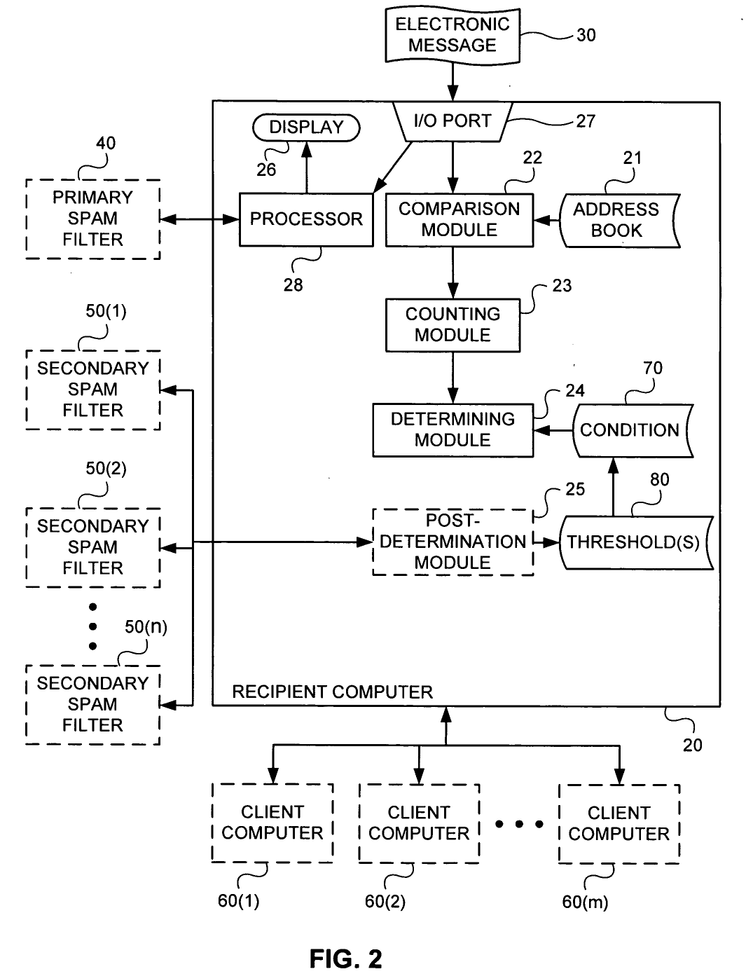

FIG. 2 illustrates one embodiment of a SLIC wherein the BORSCHT functions are distributed between a signal processor 210 and a linefeed driver 220. Signal processor 210 is responsible for at least the battery feed control, ringing control, supervision, codec, and hybrid functions. Signal processor 210 controls and interprets the large signal subscriber loop control signals as well as handling the small signal analog voiceband signals and the digital voiceband data. In one embodiment, the signal processor 210 is an integrated circuit.

In one embodiment, the signal processor includes a processor interface 214 to enable programmatic control of the signal processor 210. The processor interface effectively enables programmatic or dynamic control of battery control, battery feed state control, voiceband signal amplification and level shifting, longitudinal balance, ringing currents, and other subscriber loop control parameters as well as setting thresholds such as a ring trip detection thresholds and an off-hook detection threshold.

Signal processor 210 includes a codec for bi-directional transformation of the voiceband communications between the digital and analog domains as is well known in the art. The digital voiceband data is received from the digital switching network on interface 216. Within the signal processor, the digital voiceband data is coupled to a digital codec interface. An analog codec interface provides outgoing analog voiceband signals to the linefeed driver. The analog codec interface also receives incoming analog voiceband signals from the linefeed driver. The terms “incoming” and “outgoing” used in reference to the voiceband (i.e., audio) signal refer to the intended data flow from the perspective of the digital switching network. Thus, incoming voiceband signals received from the subscriber line are transformed from analog to digital form and provided to the digital switching network. Outgoing voiceband signals from the digital switching network are transformed from digital to analog form and provided to the subscriber line for use by the subscriber equipment.

Signal processor 210 receives subscriber line state information from linefeed driver 220 as indicated by tip/ring sense 222. This information is used to generate control signals for linefeed driver 220 as indicated by linefeed driver control 212. In one embodiment, the linefeed driver control and outgoing analog voiceband signals are communicated on the same signal lines 212. Incoming analog voiceband signals are received by the signal processor on line 230.

Linefeed driver 220 maintains responsibility for battery feed to tip 280 and ring 290. Overvoltage protection is not explicitly illustrated, however, overvoltage protection can be provided by fuses and/or a network of clamping devices incorporated into linefeed driver 220, if desired. Linefeed driver 220 includes sense circuitry to provide signal processor 210 with pre-determined sensed subscriber loop operating parameters as indicated by tip/ring sense 222. Signal processor 210 performs any necessary processing on the sensed parameters in order to determine the operational state of the subscriber loop. For example, differences or sums of sensed voltages and currents are performed as necessary by signal processor 210 rather than linefeed driver 220. Thus common mode and differential mode components (e.g., voltage and current) of the subscriber loop are calculated by the signal processor rather than the linefeed driver.

Linefeed driver 220 modifies the large signal tip and ring operating conditions in response to linefeed driver control 212 provided by signal processor 210. This arrangement enables the signal processor to perform processing as needed to handle the majority of the BORSCHT functions. For example, the supervisory functions of ring trip, ground key, and off-hook detection can be determined by signal processor 210 based on operating parameters provided by tip/ring sense 222.

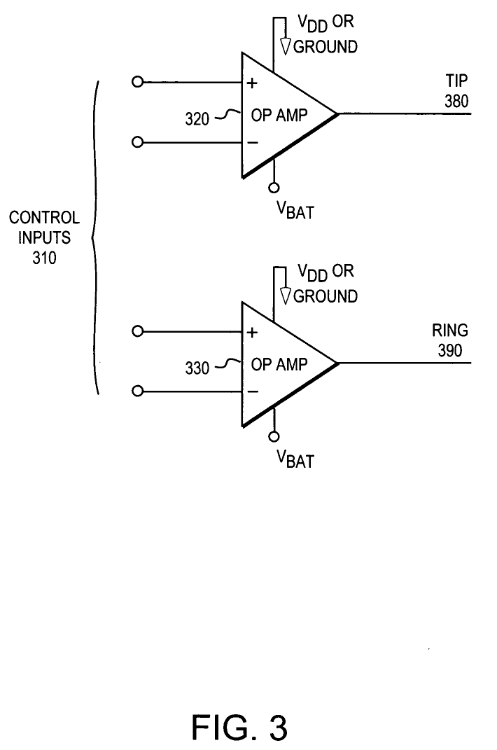

FIG. 3 illustrates one embodiment of the large signal linefeed driver circuitry for controlling tip and ring line voltages. Operational amplifier 320 controls the tip 380 portion of the subscriber line. Operational amplifier 330 controls the ring 390 portion of the subscriber line. Operational amplifiers 320 and 330 drive the tip 380 and ring 390 lines in accordance with linefeed control signals 310.

As illustrated in FIG. 3, operational amplifiers typically use V_{DD} (approximately 5 VDC) or ground for the positive rail supply voltage and V_{BAT} (−24 to −75 VDC) for the negative rail supply voltage. Thus the amplifiers are relatively high voltage amplifiers. Moreover, due to the potential difference between V_{DD} and V_{BAT}, the operational amplifier bias currents result in non-negligible power consumption. Due to subscriber loop operational specifications, operational amplifiers 320 and 330 must be matched over a relatively large operating voltage range. The operational amplifiers are frequently constructed on a shared substrate within a high voltage integrated circuit in part to facilitate matching. The dual high voltage precision operational amplifier approach tends to result in increased costs for the SLIC.

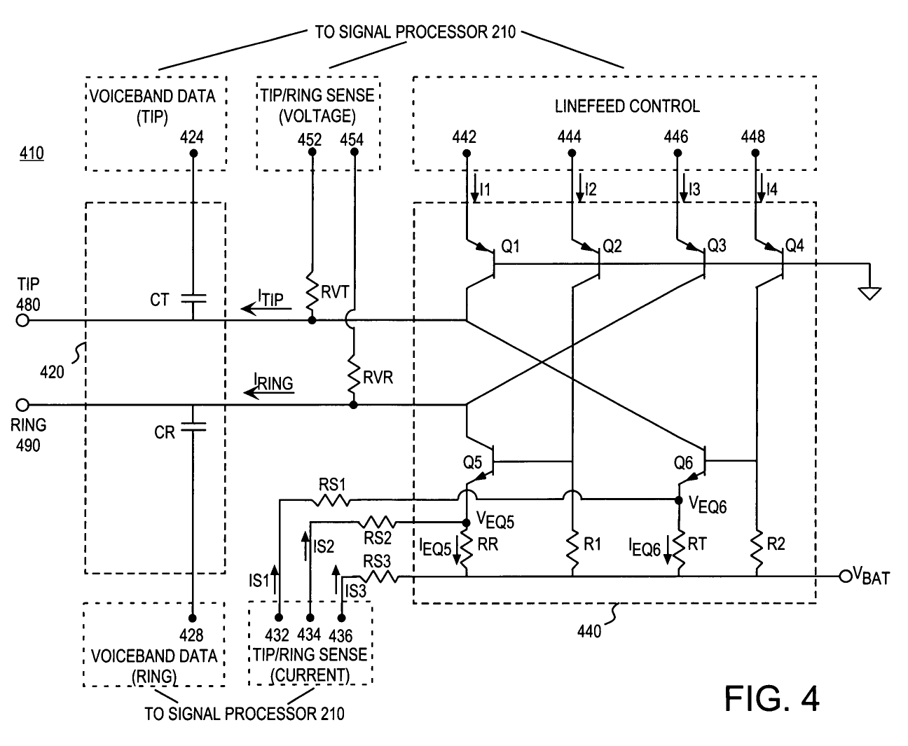

FIG. 4 illustrates an alternative SLIC linefeed driver 410. In one embodiment, the linefeed driver 410 is implemented as a number of discrete components. Linefeed driver 410 includes voiceband sensing circuitry 420 and power circuitry 440.

Voiceband circuitry 420 enables retrieval of voiceband communications from the subscriber loop. Nodes 424 and 428 serve to communicate voiceband signals from the subscriber loop to signal processor 210 (i.e., “incoming audio”). Capacitors CR and CT effectively provide AC coupling for the incoming audio signal from the subscriber loop to the signal processor while decoupling signal processor 210 from the DC offsets of the tip 480 and ring 490 nodes. Thus capacitors CR and CT effectively provide DC isolation of the incoming analog audio interface formed by nodes 424 and 428 from the subscriber loop. In the embodiment illustrated, voiceband circuitry 420 provides AC coupling of the incoming analog audio signal between the subscriber loop and the signal processor using only passive components.

Power circuitry 440 provides the battery feed and other relatively high voltage functions to the subscriber loop in accordance with analog linefeed control signals provided by the signal processor 210 at nodes 442, 444, 446, and 448. These control signals act as pull-up/pull-down controls to manipulate the tip and ring currents. Processing of the sensed parameters of the tip and ring lines for generating the linefeed control signals is handled exclusively by signal processor 210.

The subscriber loop current and the tip and ring voltages are controlled by transistors Q1-Q6. Transistors Q1-Q4 are coupled in a common base configuration. Transistors Q5-Q6 are coupled in a common emitter configuration. The common base/common emitter combination isolates the low voltage circuitry of the signal processor from the high voltage of the subscriber loop while providing pull-down current capabilities into the battery supply V_{BAT}.

Transistors Q5-Q6 function as pull-down circuitry to enable decreasing the tip and ring currents. Transistors Q1-Q4 serve as a control isolation stage to provide the control signals from the low voltage domain of the signal processor to the high voltage domain of the pull-down circuitry and the subscriber line. The voltage domain of the signal processor is approximately 0-5.0 volts. The voltage domain of the pull-down circuitry is approximately −V_{BAT} to 0.0 volts. Due to the transistor junctions between the signal ground and the remainder of the pull-down circuitry, the voltage domains of the signal processor and the pull-down circuitry will not intersect during normal operation.

In one embodiment, Q1-Q4 are PNP bipolar junction transistors and Q5-Q6 are NPN bipolar junction transistors. Given that the base terminals of Q1-Q4 are coupled to ground, nodes 442-448 need only be approximately 0.7 volts to turn on transistors Q1-Q4. Due to the small voltage drop between the base and emitters of Q1-Q4, control of the linefeed circuitry requires relatively low power and thus linefeed driver control currents 11-14 may be provided by a signal processor 210 implemented as a low voltage complementary metal oxide semiconductor (CMOS) integrated circuit. Transistors Q1, Q4, and Q6 (and resistor R2) control the tip voltage 480. The tip voltage is increased by the application of control current I1 to Q1. The tip voltage (node 480) is decreased by the application of control current I4 to Q4. Control currents I1 and I4 provide pull-up and pull-down tip control signals for manipulating the tip voltage at node 480.

Similarly, transistors Q2, Q3, and Q5 (and resistor R1) control the ring voltage 490. The application of control current I3 to Q3 increases the ring voltage. Thus I3 represents the pull-up control signal for the ring voltage. The ring voltage is decreased by the application of control current I2 to Q2. Control current I2 is the ring voltage pull-down control signal. Control currents I2 and I3 provide pull-down and pull-up ring control signals for manipulating the ring voltage at node 490.

Control currents I1-I4 thus control the large signal subscriber loop current and tip and ring voltages. For example, the ringing signal can be generated by using the control signals at nodes 442-448 to periodically reverse the polarity of tip 480 with respect to ring 490 (i.e., battery polarity reversal) at the nominal ringing frequency.

Transistors Q1-Q6 are selected to have sufficiently high betas so that base currents are negligible. Thus the tip current (I_{TIP}) can be approximated as I_{TIP}=I1-I_{EQ6}. The pull-up and pull-down controls are operated in a substantially mutually exclusive manner such that only one of I1 or I4 is nonzero at given point in time. The tip current is thus either I1 or −I_{EQ6}. As a result, the tip current can be determined indirectly by sensing the emitter current of transistor Q6. The ring current is either I3 or −I_{EQ5} and can be determined indirectly by sensing the emitter current of Q5. The tip and ring currents can thus be determined without direct sensing of the tip and ring lines.

Power circuitry 440 includes line sensing circuitry to enable determination of currents I_{EQ5} and I_{EQ6}. The line sensing circuitry includes sense resistor RR located in the emitter path of Q5 between the emitter of Q5 and V_{BAT} and sense resistor RT located in the emitter path of Q6 between the emitter of Q6 and V_{BAT} . Resistors RT and RR are used as sense impedances to generate a voltage drop (e.g., V_{EQ6}-V_{BAT} and V_{EQ5}-V_{BAT}) for determining I_{EQ6} and I_{EQ5}. The voltage drop across RT is sensed using resistors RS1 and RS3. The voltage drop across RR is sensed using RS2 and RS3. Resistors RS1, RS2, and RS3 convert the voltages at nodes V_{EQ5}, V_{EQ6}, and V_{BAT} into sense currents IS1, IS2, and IS3, respectively, for processing by signal processor 210. In one embodiment, the line sensing circuitry consists only of passive discrete components.

Referring to FIGS. 2 and 4, tip/ring sense 222 includes the sensed currents IS1, IS2, and IS3 for determination of I_{EQ6}. Currents IS1, IS2, and IS3 are provided to nodes 432, 434, and 436 so that the signal processor can perform the appropriate calculations to control the tip and ring currents from the sensed currents. The sensed parameters (IS1, IS2, and IS3 ) enable the signal processor 210 to determine the subscriber loop common mode and differential mode currents. Generally, the tip and ring currents or the departure from the desired tip and ring currents is determined indirectly in the low voltage domain of the signal processor without directly sensing the high voltage, high current tip and ring lines. Thus resistors RS1, RS2, and RS3 form a sense or feedback isolation stage to enable providing sensed parameters from the high voltage, high current domain of the power circuitry to the low voltage domain of the signal processor.

The voltage across the emitter resistor RT is proportional to the current flowing in the emitter of Q6. In particular,
V_{EQ6}−V_{BAT}=I_{EQ6}RT

Assuming RS1 and RS2 are significantly larger than emitter resistors RR and RT (and RS1≈RS3 and the nodal voltages V₄₃₂, V₄₃₄, and V₄₃₆ are substantially the same), the difference in sense currents IS1 and IS3 represents a measure of I_{EQ6} in accordance with the equation:

$${I}_{EQ6} = ( IS3 - IS1 ) \cdot \frac{RS1}{RT}$$

$$Similarly , \\ {I}_{EQ5} = ( IS3 - IS2 ) \cdot \frac{RS1}{RR}$$

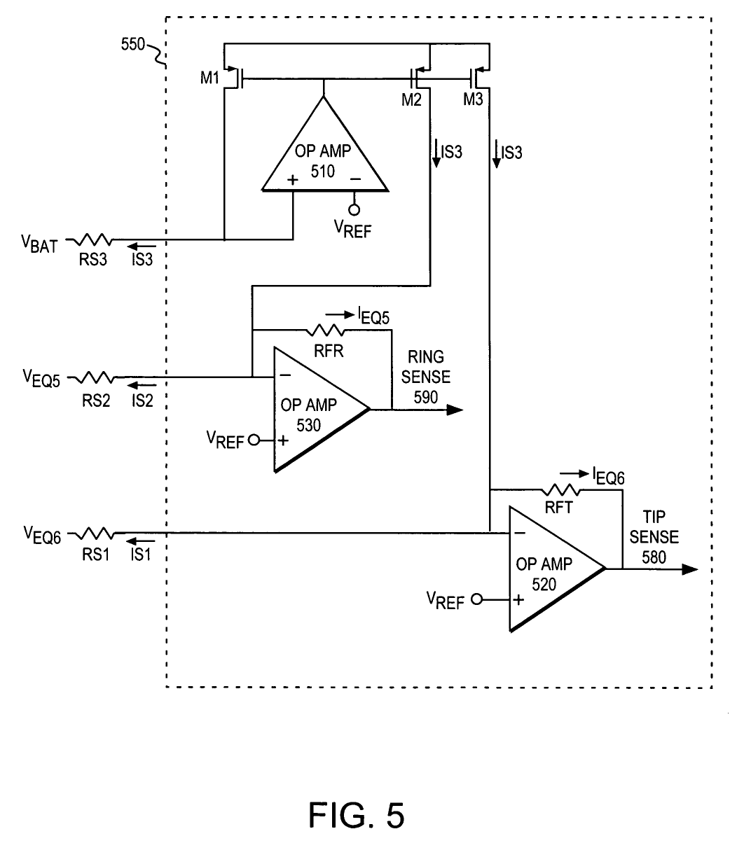

FIG. 5 illustrates low voltage tip/ring current differencing and mirroring circuitry 550 that may be incorporated into signal processor 210 for determining currents I_{EQ6} and I_{EQ5}. Operational amplifier 510 and transistors M1, M2, and M3 are used to invert and mirror IS3 to enable calculating the difference between currents IS1 and IS3 as well as the difference between IS2 and IS3. Operational amplifier 520 provides a tip sense signal 580 indicative of the current I_{EQ6} flowing through the emitter of Q6. Similarly operational amplifier 530 provides a ring sense signal 590 indicative of the current I_{EQ5} flowing through the emitter of Q5. Assuming a high beta (β) for Q5 and Q6, these emitter currents represent the subscriber line tip and ring pull-down currents. If the pull-up and pull-down control signals are operated mutually exclusively in a push-pull fashion, the pull-down currents (when non-zero) represent the tip and ring currents (allowing for a change of sign).

Operational amplifier 510 provides a virtual short circuit terminating one end of resistor RS3 at a potential voltage equivalent to V_{REF} due to the presence of V_{REF} at the inverting input of operational amplifier 510. If V_{REF} is signal ground, then RS3 is effectively terminated at a virtual ground.

Transistors M1 and M2 are coupled in a current mirror configuration such that current IS3 is mirrored through the drain of transistor M2. Similarly transistor M3 is coupled in a current mirror configuration with transistor M1 to provide current IS3 through the drain of transistor M3.

Operational amplifier 520 is a transimpedance amplifier that forces the difference between IS3 and IS1 to flow across feedback resistor RFT. As long as V_{REF} at the inverting input of amplifier 510 is the same as V_{REF} at the noninverting input of operational amplifier 520, operational amplifier 520 effectively generates a signal corresponding to the difference between IS1 and IS3. The difference between these currents is proportional to the emitter current through transistor Q6 (i.e., I_{EQ6}∝IS3-IS1 ). Thus the voltage produced as the tip sense signal 580 is proportional to I_{EQ6} (i.e., V₅₈₀ ∝RFT·I_{EQ6})

Transimpedance amplifier 530 similarly generates a ring sense voltage 590 proportional to the difference between IS2 and IS3. The difference between these currents is proportional to the emitter current through transistor Q5 (i.e., I_{EQ5}∝IS3-IS2 ). Thus the ring sense voltage V₅₉₀ is proportional to I_{EQ5} (i.e., V₅₉₀∝RFR·I_{EQ5}).

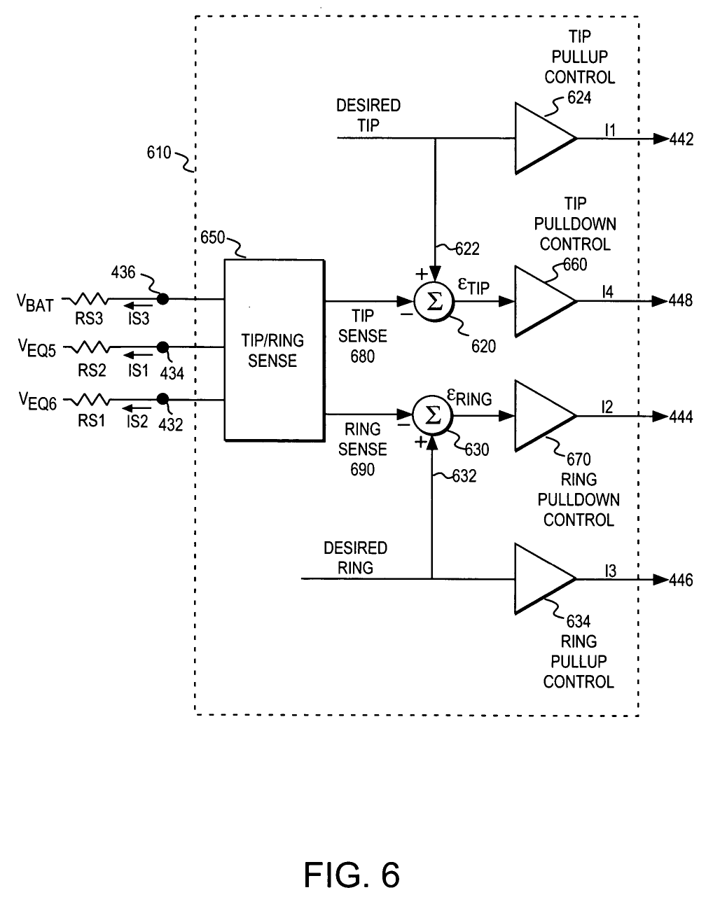

FIG. 6 illustrates the current differencing and mirroring circuitry 550 in block form as tip/ring sense circuitry 650 within signal processor 610. In one embodiment, amplifiers 624 and 634 are transconductance amplifiers for converting voltage levels corresponding to desired tip and ring currents into tip and ring pull-up currents I1 and I3. When non-zero, the tip and ring pull-up currents also correspond to the desired tip and ring currents.

The tip sense signal 680 is compared with a signal 622 corresponding to the desired tip current. Differential amplifier 620 generates a tip error signal ε_{TIP} as feedback for the tip pull-down control 660. Tip pull-down control 660 varies I4 in response to ε_{TIP}. Generally, when the actual tip current falls below the desired tip current, tip pull-up current I1 is applied. When the actual tip current exceeds the desired tip current, I4 is applied to increase the pull-down current I_{EQ5}. In one embodiment, tip and ring pull-down controls 660 and 670 are transconductance amplifiers.

The ring sense signal 690 is similarly compared with a signal 632 corresponding to the desired ring current. Differential amplifier 630 generates a ring error signal ε_{RING} as feedback for the ring pull-down control 670. Ring pull-down control 670 varies control currents I2 in response to ε_{RING}. When the actual ring current falls below the desired ring current, ring pull-up current I3 is applied. When the actual ring current exceeds the desired ring current, I2 is applied to increase the pull-down current I_{EQ6}.

Referring to FIG. 4, the values of the impedances embodied by R1 and R2 may be selected to achieve the desired frequency response and current transfer characteristics between the control currents I1-I4 and the emitter currents I_{EQ5} and I_{EQ6}. In alternative embodiments the impedances may comprise, for example, passive networks of resistors and capacitors, or active components rather than single resistors R1 and R2 as illustrated.

The line sensing circuitry enables signal processor 210 to determine the large signal state of the subscriber loop without the need for intervening active circuitry or level shifters. The line sensing circuitry allows sensing of the high voltage circuitry by the low voltage signal processor. The tip and ring error signals are generated in the low voltage domain of the signal processor. The common base/common emitter configuration isolates the low voltage signal processor from the high voltages of the subscriber line while providing pull-down current capabilities into the battery supply. In one embodiment, the signal processor resides in a low voltage integrated circuit package and the linefeed control circuitry is external to that package such that the signal processor and linefeed control circuitry do not reside on a same semiconductor substrate.

In one embodiment, the line sensing circuitry comprises only passive discrete components. The linefeed control inputs 442-448 enable signal processor 210 to actively manage the large signal state of the subscriber loop. The large signal AC and DC control loops are effectively terminated at the signal processor 210. In particular, the large signal AC and DC components of the subscriber loop control protocol can now be controlled directly by a low voltage integrated circuit. Signal processing and state determination such as off-hook, ring trip, and ring control formerly associated with high power analog circuitry can be handled predominately by the low voltage integrated circuit. In addition, the integrated circuit signal processor can handle processing of the small signal analog voiceband signals from the subscriber loop without the need for intervening active elements or level shifting circuitry.

In one embodiment, the outgoing analog audio signal is superimposed on the control currents I1 and I3 for power circuitry 440. Thus the outgoing audio signal and the linefeed control signals are provided on the same signal lines to the linefeed driver circuitry. The outgoing audio signal is communicated using nodes 442 and 446. One advantage of this configuration is that the termination impedance can be set by controlling currents I1 and I3. The use of a programmable signal processor effectively places the value of the termination impedance under programmatic control.

Transistors Q1 and Q3 are coupled in a common base configuration. Transistors Q1 and Q3 couple the outgoing audio signal received from the signal processor. In one embodiment, an audio current source manipulates I1 and I3 to put the outgoing audio signal onto the tip 480 and ring 490 nodes. This can be accomplished, for example, by superimposing the audio signal current source on the large signal control currents provided by tip control 660 and ring control 670. The common base isolation stage effectively isolates the signal processor from the DC offset of the tip 480 and ring 490 nodes.

A DC bias current is established in Q1 and Q3 with non-precision low voltage and high voltage circuitry. The DC bias does not directly affect the audio gain or balance and thus high precision is not required. Subscriber line impedance synthesis can be accomplished by providing sensed tip and ring voltages as feedback for the audio current source. Greater gain and balance control can be achieved through the use of transistors with higher or better matched betas. Alternatively, other configurations such as Darlington pairs can be used to achieve a greater beta. Different types of transistors such as metal oxide semiconductor or junction field effect transistors (i.e., MOSFET or JFET) can be used for either the common base isolation stage (Q1-Q4) or the drive transistors (Q5-Q6) in alternative embodiments. The term “common base” includes “common gate” equivalents for MOSFET and JFET transistors. Thus a “common base isolation stage” is intended to include field effect transistors coupled in a common gate configuration.

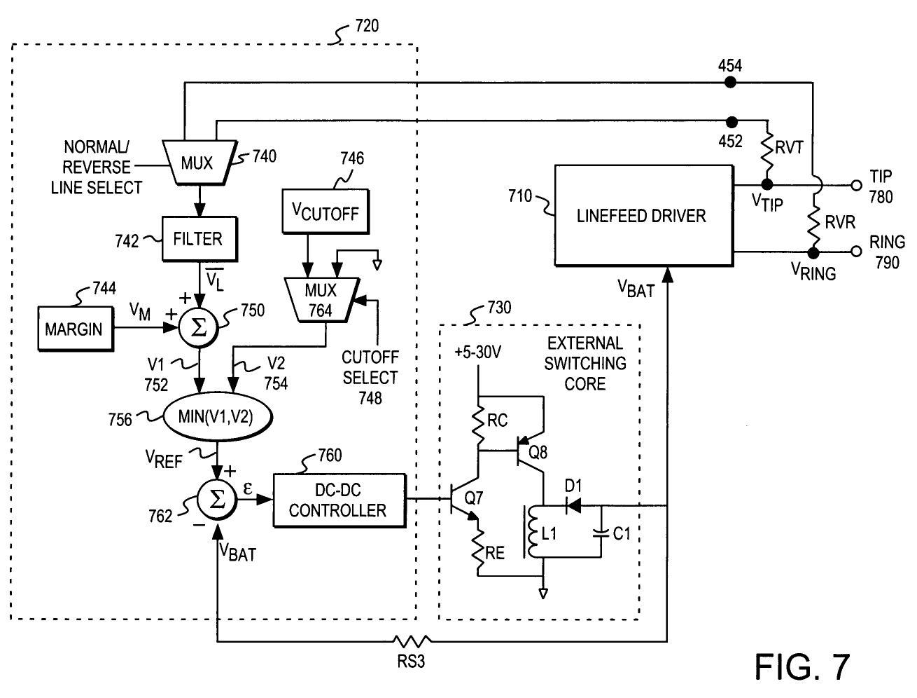

Large negative power supplies or multiple negative power supplies for V_{BAT} can be avoided by generating V_{BAT} locally. FIG. 7 illustrates the generation of a large negative voltage for V_{BAT} from only positive voltages. Referring to FIG. 4 and 7, the tip (V_{TIP}) and ring (V_{RING}) line voltages, and the battery supply voltage (V_{BAT}) are sensed using resistors RVT, RVR and RS3, respectively, and provided to voltage control circuitry 720 residing within the signal processor. In one embodiment, the voltage control circuitry 720 resides on a same semiconductor substrate as the remainder of the signal processor.

Depending upon whether the SLIC is being operated in a normal or a reverse mode, multiplexer 740 selects one of the sensed line voltages for processing. The selected line voltage signal is filtered by filter 742 to produce a filtered selected line voltage (\overline{V_{L}}) In one embodiment filter 742 is a low pass filter with a cut-off below the voice range (less than 200 Hz). In one embodiment, the filter extracts the average voltage level of the selected line for frequencies less than the pre-determined cut-off frequency. The filter reduces the effect of the audio signal on the remainder of the voltage control circuitry when the subscriber equipment is in an off hook state.

The generated battery voltage must be greater (in magnitude) than the average voltage level of the selected line by sufficient margin to ensure that the line driver operates within the normal operating region even if large audio signals are present on tip or ring. A margin 744 offset corresponding to a margin voltage (V_{M}) is added to the average voltage signal through summing amplifier or summer 750. In one embodiment, the margin 744 is a programmable value. In one embodiment, this calculated value serves as the voltage reference input (V_{REF}) for the feedback loop of the voltage control circuitry. An error signal (ε) is generated using differential amplifier 762. The error signal is proportional to the difference between the reference voltage, V_{REF} and the actual battery supply, V_{BAT}. DC-DC controller 760 controls V_{BAT} in accordance with the feedback or error signal. In one embodiment, DC-DC controller 760 provides pulse width modulation (PWM) control for V_{BAT} in response to the error signal.

A switching core 730 is located external to the signal processor. Although fed by a positive supply voltage (e.g., 5-30 Volts), switching core 730 generates the large negative battery supply voltage V_{BAT} in accordance with the PWM signal from DC-DC controller 760. Thus the switching core and the signal processor collectively form an inverting switched power supply to provide V_{BAT} for linefeed driver 710. V_{BAT} is also provided to the feedback loop of the DC-DC controller 760 through sense resistor RS3. V_{BAT} will be maintained at the voltage level determined by the average selected line voltage (i.e., filtered selected line voltage) value and the margin offset. This first mode of operation is referred to as tracking because V_{BAT} varies as necessary to keep up with changes in the average selected line voltage. In one embodiment, V_{BAT} tracks the filtered selected line voltage independently of whether the subscriber equipment is on hook or off hook.

In some situations, rapid switching between on hook and off hook conditions is required (for example, call waiting caller identification functions). The DC-DC controller may not be capable of swinging V_{BAT} across its entire expected range within short time periods, if the full range of V_{BAT} is maintained. In order to alleviate this condition, a second mode of operation is provided to limit V_{BAT} to a cutoff value to ensure faster recovery. Stating the conditionals in terms of absolute values:

$${V}_{REF} = \{ \begin{matrix}V1 , if \vert \overline{{V}_{L}} + {V}_{M} \vert > \vert {V}_{CUTOFF} \vert \\ V2 , if \vert \overline{{V}_{L}} + {V}_{M} \vert \leq \vert {V}_{CUTOFF} \vert\end{matrix} , \\ where V1 = \overline{{V}_{L}} + {V}_{M} , V2 = {V}_{CUTOFF} .$$

Considering that V_{CUTOFF} is negative, however, we can restate the conditionals and substitute for V1 and V2 when considering actual values as follows:

$${V}_{REF} = \{ \begin{matrix}\overline{{V}_{L}} + {V}_{M} , if \overline{{V}_{L}} + {V}_{M} < {V}_{CUTOFF} \\ {V}_{CUTOFF} , if \overline{{V}_{L}} + {V}_{M} \geq {V}_{CUTOFF}\end{matrix} .$$

Function block 756 thus selects the lesser of V1 and V2 (i.e., min(V1, V2) or min(\overline{V_{L}}+V_{M}, V_{CUTOFF})). Although expressed in terms of voltages, the calculations within the signal processor are performed using currents. Given that the larger (in magnitude) currents correspond to more negative voltages, function block 756 actually selects the greater (in magnitude) of the two current signals. If the voltages are represented by positive currents, function block 756 is actually selecting the maximum current.

Multiplexer 764 is provided to permit selecting modes between the tracking mode and the fixed cutoff mode for control of V_{BAT}. In one embodiment, multiplexer 764 selects V_{CUTOFF} 746 or signal ground in accordance with cutoff select signal 748. When V_{CUTOFF} 746 is selected, V_{REF} (and thus V_{BAT}) will be limited to the more negative value of V_{CUTOFF} whenever \overline{V_{L}}+V_{M} is greater (i.e., less negative) than or equal to V_{CUTOFF}. Whenever multiplexer 764 selects signal ground, function block 756 will always select V1 such that the signal processor will be in tracking mode for V_{BAT}. Any value greater than the expected operating range of \overline{V_{L}}+V_{M} can be substituted for the signal ground input of multiplexer 764, if desired.

Regardless of the maintenance mode selected for V_{BAT}, the signal processor and the power supply for the external switching core both operate within a first voltage domain (>0). V_{BAT} resides in a second voltage domain (<0 V). The first and second voltage domains are substantially distinct. In one embodiment, the switching core and signal processor form an inverting switched mode power supply.

In the preceding detailed description, the invention is described with reference to specific exemplary embodiments thereof. Various modifications and changes may be made thereto without departing from the broader spirit and scope of the invention as set forth in the claims. The specification and drawings are, accordingly, to be regarded in an illustrative rather than a restrictive sense.

1. A subscriber line interface circuit apparatus, comprising:
a switching core generating a subscriber line battery supply voltage (V_{BAT}) from a first supply voltage, the first supply voltage being more positive than V_{BAT}; and
voltage control circuitry controlling the switching core to provide the V_{BAT} that tracks at least one of a tip and a ring signal as a tracked signal.

2. The apparatus of claim 1 wherein the voltage control circuitry varies V_{BAT} to maintain a pre-determined margin from the tracked signal.

3. The apparatus of claim 2 wherein the pre-determined margin is set programmatically.

4. The apparatus of claim 1 wherein the first supply voltage resides in a positive voltage domain and V_{BAT} resides in a negative voltage domain.

5. The apparatus of claim 4 wherein the positive voltage domain has an upper bound of approximately 30 volts.

6. The apparatus of claim 1 further comprising:
a filter to eliminate frequency components above a cut-off frequency from the selected one of the tip and ring signals to provide the tracked signal.

7. The apparatus of claim 6 wherein the pre-determined cutoff frequency is approximately 200 Hz.

8. The apparatus of claim 6 wherein the voltage control circuitry resides within an integrated circuit.

9. The apparatus of claim 1 wherein the voltage control circuitry is fabricated as a complementary metal oxide semiconductor (CMOS) integrated circuit.

10. A subscriber line interface circuit apparatus, comprising:
a switching core generating a negative subscriber line battery supply voltage (V_{BAT}) from a positive first supply voltage; and
voltage control circuitry controlling the switching core in accordance with a programmable reference voltage (V_{REF}).

11. The apparatus of claim 10 wherein V_{REF} represents a sum (V1) of a programmable margin (V_{M}) and a tracked signal corresponding to a least one of a tip and a ring signal.

12. The apparatus of claim 10 wherein V_{REF} represents a selected one of a programmable cutoff voltage (V2) or a sum (V1) of a programmable margin (V_{M}) and at least one of a tip and a ring signal.

13. The apparatus of claim 11 further comprising:
a filter eliminating frequency components above a cut-off frequency from the selected one of the tip and ring signals to provide the tracked signal, wherein the cut-off frequency is below a voice range.

14. The apparatus of claim 10 wherein the voltage control circuitry resides within an integrated circuit package.

15. The apparatus of claim 14 wherein the switching core is external to the integrated circuit package.

16. The apparatus of claim 10 wherein the voltage control circuitry is fabricated as a complementary metal oxide semiconductor (CMOS) integrated circuit.

17. The apparatus of claim 10 wherein the switching core further comprises an inverting DC-DC converter.

18. A subscriber line interface apparatus comprising:
a switching core generating a negative subscriber line battery supply voltage (V_{BAT}) for supplying at least one of a tip line and a ring line of a subscriber line from a positive first supply voltage; and
voltage control circuitry driving the switching core in accordance with a tracked signal corresponding to a sensed one of the tip and ring lines.

19. The apparatus of claim 18 wherein the voltage control circuitry further comprises a DC-DC controller.

20. The apparatus of claim 18 wherein the voltage control circuitry resides within an integrated circuit.
